(19) United States
(12) Patent Application Publication
(10) Pub. No.: US 2024/0406662 A1
(43) Pub. Date: Dec. 5, 2024

(54) API for Spatial Audio Controls

(71) Applicant: Apple Inc., Cupertino, CA (US)

(72) Inventors: Stephen E. Pinto, Mountain View, CA (US); Akshatha Nagesh, Sunnyvale, CA (US); Deepak Iyer, Mountain View, CA (US); Eric J. Johnson, Morgan Hill, CA (US); Madhur Ahuja, Santa Clara, CA (US); Sanket S. Dave, Sunnyvale, CA (US); Shai Messingher Lang, Santa Clara, CA (US)

(21) Appl. No.: 18/672,948

(22) Filed: May 23, 2024

Related U.S. Application Data
(60) Provisional application No. 63/470,693, filed on Jun. 2, 2023.

(51) Int. Cl. H04S 7/00; H04S 1/00

(52) U.S. Cl. CPC H04S 7/303; H04S 1/007

(57) ABSTRACT

In one implementation, a method of playing audio is performed by a device located in a physical environment, coupled to two or more speakers, and including one or more processors and non-transitory memory. The method includes executing an operating system and an application. The method includes receiving, by the operating system from the application via an application programming interface, audio session parameters including a spatial experience value providing instructions for the spatial playback of audio associated with the application. The method includes receiving, by the operating system from the application, instructions to play audio data. The method includes adjusting, by the operating system, the audio data based on the spatial experience value. The method includes sending, by the operating system to the two or more speakers, the adjusted audio data.

### CROSS-REFERENCE TO RELATED APPLICATIONS

This application claims priority to U.S. Provisional Patent App. No. 63/470,693, filed on Jun. 2, 2023, which is hereby incorporated by reference in its entirety.

### TECHNICAL FIELD

The present disclosure generally relates to systems, methods, and devices of controlling the spatial presentation of sounds via an application programming interface (API).

### BACKGROUND

In various implementations, an extended reality (XR) environment presented by an electronic device including a display includes one or more scenes displayed by applications. Further, the electronic device includes two or more speakers that play audio provided by the applications. However, developers do not have a simple way to define how the audio will be spatialized in the XR environment.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIG. 1 is a block diagram of an example operating environment in accordance with some implementations.

FIGS. 2A and 2B illustrate an XR environment during various time periods in accordance with some implementations.

FIG. 3 illustrates an electronic device in accordance with some implementations.

FIG. 4 is a flowchart representation of a method of displaying an image in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### SUMMARY

Various implementations disclosed herein include devices, systems, and methods for playing audio. In various implementations, the method is performed by a device located in a physical environment, coupled to two or more speakers, and including one or more processors and non-transitory memory. The method includes executing an operating system and an application. The method includes receiving, by the operating system from the application via an application programming interface, audio session parameters including a spatial experience value providing instructions for the spatial playback of audio associated with the application. The method includes receiving, by the operating system from the application, instructions to play audio data. The method includes adjusting, by the operating system, the audio data based on the spatial experience value. The method includes sending, by the operating system to the two or more speakers, the adjusted audio data.

In accordance with some implementations, a device includes one or more processors, a non-transitory memory, and one or more programs; the one or more programs are stored in the non-transitory memory and configured to be executed by the one or more processors and the one or more programs include instructions for performing or causing performance of any of the methods described herein. In accordance with some implementations, a non-transitory computer readable storage medium has stored therein instructions, which, when executed by one or more processors of a device, cause the device to perform or cause performance of any of the methods described herein. In accordance with some implementations, a device includes: one or more processors, a non-transitory memory, and means for performing or causing performance of any of the methods described herein.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices and circuits have not been described in exhaustive detail so as not to obscure more pertinent aspects of the example implementations described herein.

In various implementations, an extended reality (XR) environment presented by an electronic device including a display includes one or more scenes displayed by applications. Further, the electronic device includes two or more speakers that play audio provided by the applications. Developers can, via an application programming interface (API), indicate how the audio is to be spatialized in the XR environment. In particular, an audio session API is provided that allows an application developer to instruct an operating system to instantiate an audio session that plays the audio to effect a head-tracked spatial experience, a fixed spatial experience, or a non-spatial experience.

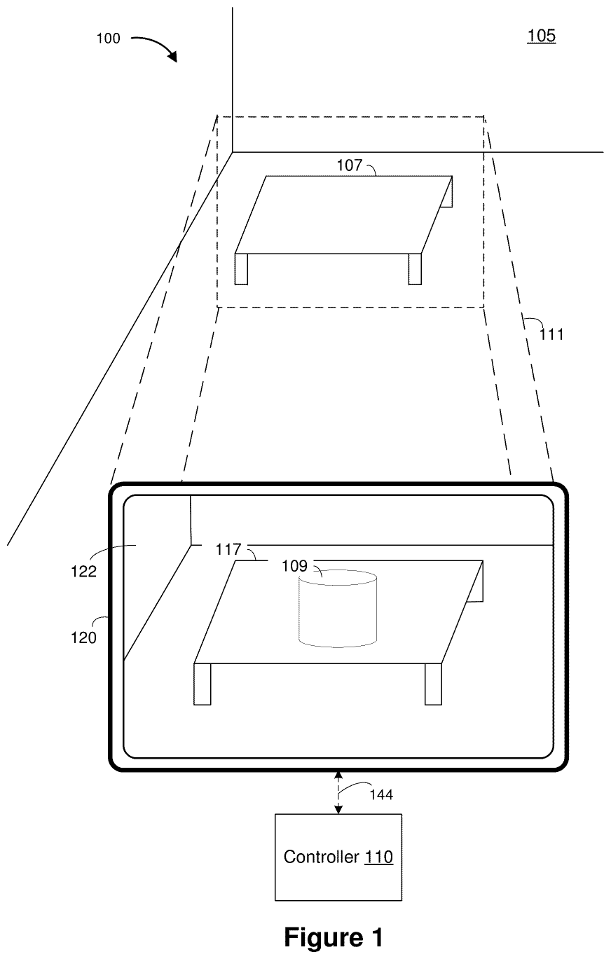

FIG. 1 is a block diagram of an example operating environment 100 in accordance with some implementations. While pertinent features are shown, those of ordinary skill in the art will appreciate from the present disclosure that various other features have not been illustrated for the sake of brevity and so as not to obscure more pertinent aspects of the example implementations disclosed herein. To that end, as a non-limiting example, the operating environment 100 includes a controller 110 and an electronic device 120.

In some implementations, the controller 110 is configured to manage and coordinate an XR experience for the user. In some implementations, the controller 110 includes a suitable combination of software, firmware, and/or hardware. The controller 110 is described in greater detail below with respect to FIG. 8. In some implementations, the controller 110 is a computing device that is local or remote relative to the physical environment 105. For example, the controller 110 is a local server located within the physical environment 105. In another example, the controller 110 is a remote server located outside of the physical environment 105 (e.g., a cloud server, central server, etc.). In some implementations, the controller 110 is communicatively coupled with the electronic device 120 via one or more wired or wireless communication channels 144 (e.g., BLUETOOTH, IEEE 802.11x, IEEE 802.16x, IEEE 802.3x, etc.). In another example, the controller 110 is included within the enclosure of the electronic device 120. In some implementations, the functionalities of the controller 110 are provided by and/or combined with the electronic device 120.

In some implementations, the electronic device 120 is configured to provide the XR experience to the user. In some implementations, the electronic device 120 includes a suitable combination of software, firmware, and/or hardware. According to some implementations, the electronic device 120 presents, via a display 122, XR content to the user while the user is physically present within the physical environment 105 that includes a table 107 within the field-of-view 111 of the electronic device 120. As such, in some implementations, the user holds the electronic device 120 in his/her hand(s). In some implementations, while providing XR content, the electronic device 120 is configured to display an XR object (e.g., an XR cylinder 109) and to enable video pass-through of the physical environment 105 (e.g., including a representation 117 of the table 107) on a display 122. The electronic device 120 is described in greater detail below with respect to FIG. 9.

According to some implementations, the electronic device 120 provides an XR experience to the user while the user is virtually and/or physically present within the physical environment 105.

In some implementations, the user wears the electronic device 120 on his/her head. For example, in some implementations, the electronic device includes a head-mounted system (HMS), head-mounted device (HMD), or head-mounted enclosure (HME). As such, the electronic device 120 includes one or more XR displays provided to display the XR content. For example, in various implementations, the electronic device 120 encloses the field-of-view of the user. In some implementations, the electronic device 120 is a handheld device (such as a smartphone or tablet) configured to present XR content, and rather than wearing the electronic device 120, the user holds the device with a display directed towards the field-of-view of the user and a camera directed towards the physical environment 105. In some implementations, the handheld device can be placed within an enclosure that can be worn on the head of the user. In some implementations, the electronic device 120 is replaced with an XR chamber, enclosure, or room configured to present XR content in which the user does not wear or hold the electronic device 120.

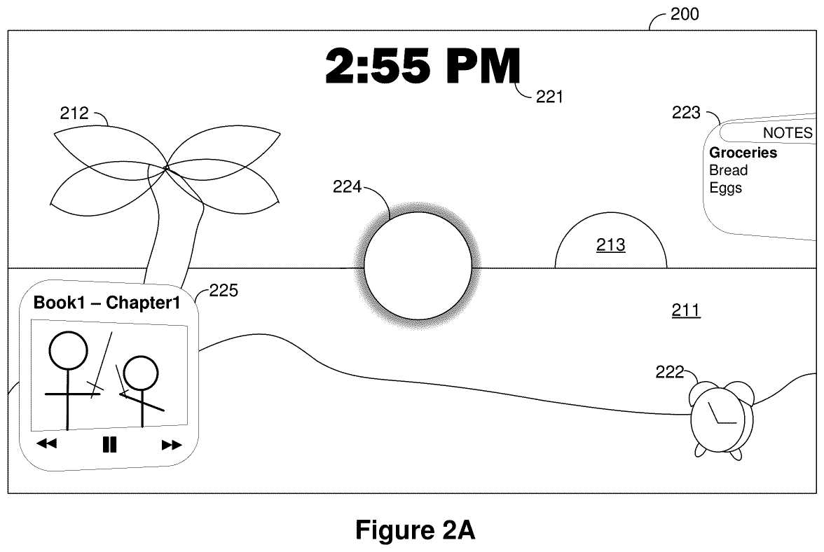

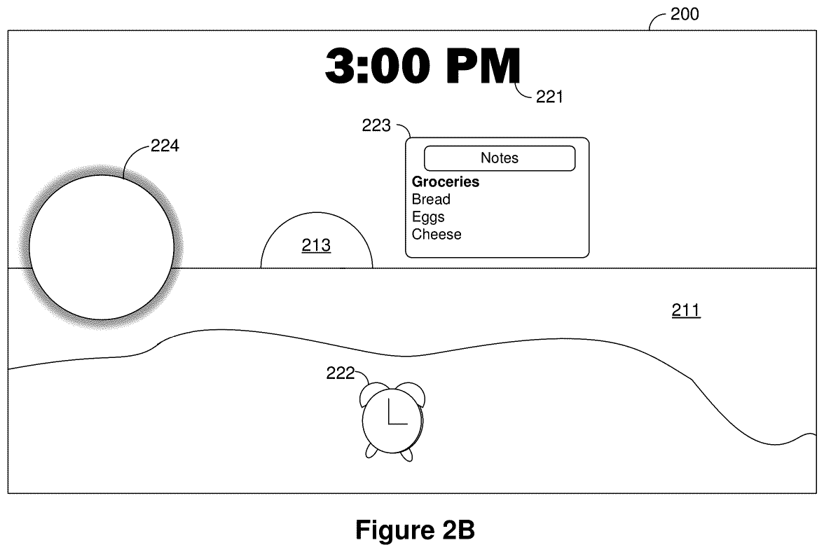

FIGS. 2A and 2B illustrate an XR environment 200 from the perspective of a user of an electronic device displayed, at least in part, by a display of the electronic device. In various implementations, the perspective of the user is from a location of an image sensor of the electronic device. For example, in various implementations, the electronic device is a handheld electronic device and the perspective of the user is from a location of the image sensor of the handheld electronic device directed towards the physical environment. In various implementations, the perspective of the user is from the location of a user of the electronic device. For example, in various implementations, the electronic device is a head-mounted electronic device and the perspective of the user is from a location of the user directed towards the physical environment, generally approximating the field-of-view of the user were the head-mounted electronic device not present. In various implementations, the perspective of the user is from the location of an avatar of the user. For example, in various implementations, the XR environment 200 is a virtual environment and the perspective of the user is from the location of an avatar or other representation of the user directed towards the virtual environment.

FIGS. 2A and 2B illustrate the XR environment 200 during a series of time periods. In various implementations, each time period is an instant, a fraction of a second, a few seconds, a few hours, a few days, or any length of time.

The XR environment 200 includes a plurality of objects, including one or more real objects (e.g., an ocean 211, a tree, 212, and the sun 213) and one or more virtual objects (e.g., a virtual digital clock 211 of a clock application, a virtual alarm clock 222 of the clock application, a virtual notes window 223 of a notes application, a virtual audiobook window 224 of an audiobook application, and a virtual sphere 225 of a meditation application). In various implementations, certain objects (such as the real objects, the virtual alarm clock 222, the virtual audiobook window 224, and the virtual sphere 225) are displayed at a location in the XR environment 200, e.g., at a location defined by three coordinates in a three-dimensional (3D) XR coordinate system. Accordingly, when the electronic device moves in the XR environment 200 (e.g., changes either position and/or orientation), the objects are moved on the display of the electronic device, but retain their location in the XR environment 200. Such virtual objects that, in response to motion of the electronic device, move on the display, but retain their position in the XR environment 200 are referred to as world-locked objects. In various implementations, certain virtual objects (such as the virtual digital clock 221) are displayed at locations on the display such that when the electronic device moves in the XR environment 200, the objects are stationary on the display on the electronic device. Such virtual objects that, in response to motion of the electronic device, retain their location on the display are referred to as head-locked objects or display-locked objects.

FIG. 2A illustrates the XR environment 200 during a first time period. During the first time period, the virtual digital clock 221 is displayed at a digital clock location of the display. During the first time period, the virtual alarm clock 222 is displayed at a first alarm clock location on the display (on a right side of the display) corresponding to an alarm clock location in the XR environment 200. In various implementations, during the first time period, the clock application instructs the Electronic device to produce sound (e.g., a ticking that increases in volume as an alarm time approaches) from the alarm clock location in the XR environment 200. Accordingly, the user perceives the sound as being produced from virtual alarm clock 222 at the first alarm clock location on the display, e.g., to the user's right. During the first time period, the virtual notes window 223 is displayed at a first notes window location on the display (on a right side of the display) corresponding to a notes window location in the XR environment 200. In various implementations, during the first time period, the notes application instructs the electronic device to produce sound (e.g., a chime to indicate that another user has edited a shared note being displayed in the virtual notes window 223) from the notes window location in the XR environment 200. Accordingly, the user perceives the sound as being produced from virtual notes window 223 at the first notes window location on the display, e.g., to the user's right.

During the first time period, the virtual sphere 224 is displayed at a first sphere location on the display (in the center of the display) corresponding to a sphere location in the XR environment 200. In various implementations, the virtual sphere 224 periodically increases and decreases in size and/or glow intensity to indicate a breathing pattern to a user. In various implementations, during the first time period, the meditation application instructs the electronic device to produce sound independent of the sphere location or the pose of the electronic device. In particular, the meditation application provides a left audio stream to be played, unchanged, by a left speaker and a right audio stream to be played, unchanged, by a right speaker. For example, in various implementations, the meditation application instructs the device produce binaural beats that would be reduced or nullified by spatially locating the left audio stream and right audio stream.

During the first time period, the virtual audiobook window 225 is displayed at a first audiobook window location on the display (on a left side of the display) corresponding to an audiobook window location in the XR environment 200. In various implementations, during the first time period, the audiobook application instructs the electronic device to produce sound (e.g., of an audiobook being read) from a location in front of the user during the first time period. In particular, the location in front of the user during the first time period is not the audiobook window location in the XR environment 200, but a location in front of the user that changes its corresponding location in the XR environment 200 as the user (and the device) moves.

FIG. 2B illustrates the XR environment 200 during a second time period subsequent to the first time period. During the second time period, as compared to the first time period, the pose of the electronic device has changed from the first pose to a second pose. In particular, the electronic device has moved to the right.

During the second time period, the virtual digital clock 221 is displayed at the digital clock location of the display. Thus, between the first time period and the second time period, the virtual digital clock 221 has not moved on the display.

During the second time period, the virtual alarm clock 222 is displayed at a second alarm clock location on the display (in the center of the display) corresponding to the alarm clock location in the XR environment 200. Thus, between the first time period and the second time period, the virtual alarm clock 222 has not moved in the XR environment 200, but is moved to the left on the display. In various implementations, during the second time period, the clock application instructs the electronic device to produce sound (e.g., an alarm) from the alarm clock location in the XR environment 200. Accordingly, the user perceives the sound as being produced from virtual alarm clock 222 at the second alarm clock location on the display, e.g., in front of the user. During the second time period, the virtual notes window 223 is displayed at a second notes window location on the display (in the center of the display) corresponding to the notes window location in the XR environment 200. Thus, between the first time period and the second time period, the virtual notes window 223 has not moved in the XR environment 200, but is moved to the left on the display. In various implementations, during the second time period, the notes application instructs the electronic device to produce sound (e.g., a chime to indicate that another user has edited a shared note being displayed in the virtual notes window 223) from the notes window location in the XR environment 200. Accordingly, the user perceives the sound as being produced from virtual notes window 223 at the second notes window location on the display, e.g., in front of the user.

During the second time period, the virtual sphere 224 is displayed at a second sphere location on the display (on a left side of the display) corresponding to the sphere location in the XR environment 200. In various implementations, during the second time period, the meditation application instructs the electronic device to produce sound independent of the sphere location or the pose of the electronic device. In particular, the meditation application provides a left audio stream to be played, unchanged, by a left speaker and a right audio stream to be played, unchanged, by a right speaker. For example, in various implementations, the meditation application instructs the device produce binaural beats that would be reduced or nullified by spatially locating the left audio stream and right audio stream. Thus, the perceived location (if any) of the sound produced in accordance with the meditation application's instructions, is unchanged between the first time period and the second time period.

During the second time period, the virtual audiobook window 225 is not displayed as the corresponding audiobook window location in the XR environment 200 is outside a current field-of-view. However, in various implementations, during the second time period, the audiobook application instructs the electronic device to produce sound (e.g., of an audiobook being read) from a location in front of the user during the second time period. In particular, the location in front of the user during the second time period is not the audiobook window location in the XR environment 200, nor the location in front of the user during the first time period, but a location in front of the user that changes its corresponding location in the XR environment 200 as the user (and the device) moves.

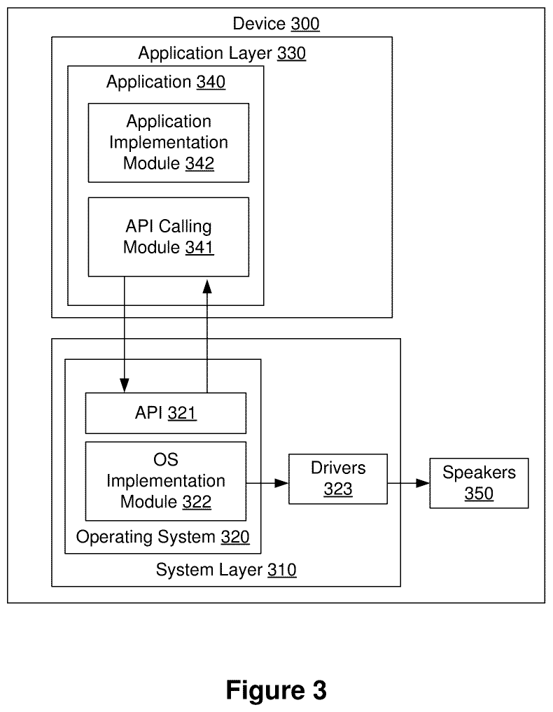

FIG. 3 is a functional block diagram of a device 300 in accordance with some implementations. The device 300 includes a system layer 310, an application layer 330, and two or more speakers 350. The system layer 310 includes an operating system 320 and one or more drivers 323. The application layer 330 includes an application 340 with an application implementation module 241 and an API calling module 341. The operating system 320 includes an API 321 and an OS implementation module 322. In various implementations, the API 321 is a software module (e.g., a collection of computer-readable instructions) that provides an interface that allows a different module (e.g., API calling module 341) to access and use one or more functions, methods, procedures, data structures, classes, and/or other services provided by the OS implementation module 322 of the operating system 320. The API 321 can define one or more parameters that are passed between the API calling module 341 and the OS implementation module 322. The OS implementation module 322 is an operating system software module (e.g., a collection of computer-readable instructions) that is constructed to perform an operation in response to receiving an API call via the API 321. In some embodiments, the OS implementation module is constructed to provide an API response (via the API 321) as a result of processing an API call.

In various implementations, the API 321 receives, from the API calling module 341, audio session parameters including a spatial experience value providing spatialization instructions for the spatial playback of audio. In various implementations, the API 321 includes an audio session API which receives the audio session parameters. In response, the OS implementation module 322 instantiates an audio session for the application 340 based on the audio session parameters. In various implementations, the API 321 receives, from the API calling module 341, instructions to play audio data. In various implementations, the API 321 includes an audio playback API which receives the instruction to play audio data. In response, the OS implementation module 322 plays the audio data according to the audio session parameters (including the spatial experience value). In various implementations, the OS implementation module 322 plays the audio data by providing instructions to the drivers 323 to drive the speakers 350.

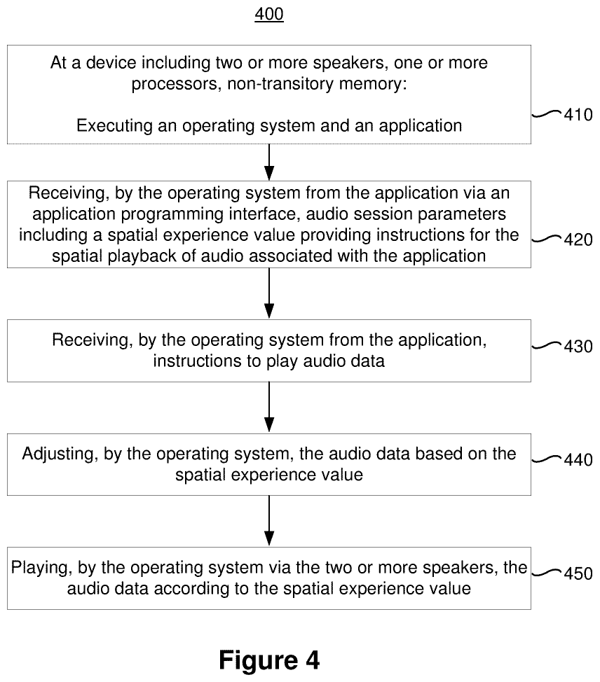

FIG. 4 is a flowchart representation of a method 400 of playing audio in accordance with some implementations. In various implementations, the method 400 is performed by an electronic device, such as the electronic device 120 of FIG. 1 or the electronic device 300 of FIG. 3. In various implementations, the method 400 is performed by a device located in a physical environment, coupled to two or more speakers, and including one or more processors and non-transitory memory. In some implementations, the method 400 is performed by processing logic, including hardware, firmware, software, or a combination thereof. In some implementations, the method 400 is performed by a processor executing instructions (e.g., code) stored in a non-transitory computer-readable medium (e.g., a memory).

The method 400 begins, in block 410, with the device executing an operating system and an application. The method 400 continues, in block 420, with the device receiving, by the operating system from the application via an application programming interface, audio session parameters including a spatial experience value providing instructions from spatial playback of audio associated with the application. In various implementations, the spatial experience value is a string indicating a spatial experience. For example, in various implementations, the spatial experience value indicates a head-tracked spatial experience, a fixed (or non-head-tracked) spatial experience, or a non-spatial experience (or bypassed spatial experience). In various implementations, in response to receiving the audio session parameters, the operating system instantiates an audio session for the application according to the audio session parameters.

The method 400 continues, in block 430, with the device receiving, by the operating system from the application, instructions to play audio data. In various implementations, the operating system receives the instructions to play audio data via the application programming interface. In various implementations, the application programming interface includes an audio session application programming interface (which receives, in block 420, the audio session parameters) and an audio playback application programming interface (which receives, in block 430, the instructions to play audio data).

The method 400 continues, in block 440, with the device adjusting, by the operating system, the audio data based on the spatial experience value. The method 400 continues, in block 450, with the device sending, by the operating system to the two or more speakers, the adjusted audio data.

In various implementations, the spatial experience value indicates a head-tracked spatial experience and adjusting the audio data includes adjusting the audio data to play from a location in the physical environment. In various implementations, the audio data is spatialized to play from the location in the physical environment using binaural rendering in which a source signal is filtered with two head-related transfer functions (HRTFs) that are based on the relative position of the head of the user and the location in the physical environment (e.g., determined using head tracking) and the resultant signals are played by two speakers respectively proximate to the two cars of the user.

In various implementations, the audio session parameters further include an anchoring value indicative of the location in the physical environment. For example, in various implementations, the anchoring value indicates a scene having a location in the physical environment. For example, in FIGS. 2A and 2B, the clock application provides a spatial experience value indicating a head-tracked spatial experience and further provides a location of the virtual alarm clock 222 in the XR environment 200. Accordingly, the electronic device plays audio data from the location of the virtual alarm clock 222. In various implementations, the anchoring value indicates an element of a scene, such as a particular object (e.g., a virtual horn or a virtual window) or a particular user interface element (e.g., a button of a virtual window). In various implementations, the anchoring value indicates a default location in the physical environment. For example, in various implementations, the anchoring value indicates a front of the physical environment. In various implementations, the front of the physical environment is designated upon powering on the device. In various implementations, the front of the physical environment may be changed by a user during use of the device. In various implementations, the anchoring value indicates a set of three-dimensional coordinates in a three-dimensional world coordinate system of the physical environment.

In various implementations, the audio session parameters further include a size value indicative of a size of the location in the physical environment and adjusting the audio data including adjusting the audio data to play from the location in the physical environment having the size. In various implementations, the audio data is sized to play from the location in the physical environment having the size by adjusting a virtual speaker size, gain, delay, reverb, or other audio parameters. In various implementations, the size may be small (which plays as though from a point source at the location in the physical environment), medium (which plays as a small theater encompassing the location in the physical environment), or large (which plays as an immersive experience centered at the location in the physical environment).

In various implementations, the audio session parameters further include an attenuation value indicative of a distance attenuation and adjusting the audio data includes adjusting a volume of the audio data based on a distance between the device and the location in the physical environment. In various implementations, the attenuation value may be indicative of disabled distance attenuation and adjusting the audio data includes adjusting the audio data independently of the distance between the device and the location in the physical environment.

In various implementations, the spatial experience value indicates a fixed spatial experience and adjusting the audio data includes adjusting the audio data to play from a location relative to the device. In various implementations, the audio data is spatialized to play from the location relative to the device using binaural rendering in which a source signal is filtered with two head-related transfer functions (HRTFs) that are based on the location relative to the device (and independent of the pose of the device) and the resultant signals are played by two speakers respectively proximate to the two cars of the user.

In various implementations, the audio session parameters further include an anchoring value indicative of the location relative to the device. For example, in FIGS. 2A and 2B, the audiobook application (and/or a podcast application) provides a spatial experience value indicating a fixed spatial experience and further provides a location in front of the electronic device. Accordingly, the electronic device plays audio data from in front of the electronic device. In various implementations, the anchoring value indicates a default location relative to the device. For example, in various implementations, the anchoring value indicates a location in front of the device. In various implementations, the anchoring value indicates a set of three-dimensional coordinates in a three-dimensional device coordinate system of the device. In various implementations, the anchoring value indicates an angle with respect to the device. For example, in various implementations, the anchoring value indicates a location to the left of the device, in front of the device, to the right of the device, or behind the device.

In various implementations, the audio session parameters further include a size value indicative of a size of the location relative to the device and adjusting the audio data includes adjusting the audio data to play from the location relative to the device having the size. In various implementations, the audio data is sized to play from the location relative to the device having the size by adjusting a virtual speaker size, gain, delay, reverb, or other audio parameters. In various implementations, the size may be small (which plays as though from a point source at the location in the physical environment), medium (which plays as a small theater encompassing the location in the physical environment), or large (which plays as an immersive experience centered at the location in the physical environment).

In various implementations, the spatial experience value indicates a non-spatial experience and adjusting the audio data includes adjusting the audio data without performing spatialization. For example, in FIGS. 2A and 2B, the meditation application provides a spatial experience value indicating a non-spatial experience and the electronic device plays the audio data as received.

In various implementations, if the operating system receives instructions to instantiate an audio session with a spatial experience value, the operating system instantiates the audio session with the spatial experience value set to the received spatial experience value. In various implementations, if the operating system receives instructions to instantiate an audio session without receiving a spatial experience value from the application, the operating system instantiates the audio session with the spatial experience value set to an automatic value indicating that the operating system chooses the spatial experience value in response to receiving instructions to play audio data. In various implementations, the operating system defaults to choosing the spatial experience value indicating a head-tracked spatial experience with a medium size at the location of a scene displayed by the application. However, in various applications, the operating system chooses a different spatial experience value, a different size, or a different location. For example, in various implementations, the operating system chooses a non-head-tracked spatial experience at a front location for long-form audio applications (e.g., music, audiobook, or podcast players). As another example, in various implementations, the operating system chooses a large size for video applications or native applications or may choose a small size for picture-in-picture applications. Thus, in various implementations, the operating system chooses the spatial experience value, size, and/or location based on other data provided by the application via the application programming interface.

As noted above, in various implementations, the operating system receives instructions to instantiate an audio session with a spatial experience value and the operating system instantiates the audio session with the spatial experience value set to the received spatial experience value. In various implementations, the operating system further receives, from a user, a user input overriding the spatial experience value with a user value. For example, in various implementations, a user may provide a user input to downgrade a spatial experience to a non-spatial experience. Thus, in various implementations, the method further includes adjusting the audio data according to the user value.

As noted above, in various implementations, the audio session parameters further include an attenuation value indicative of a distance attenuation and adjusting the audio data includes adjusting a volume of the audio data based on a distance between the device and the location in the physical environment. In various implementations, the attenuation value is one of a plurality of preset values (e.g., enabled or disabled). In various implementations, the attenuation value is defined on a sliding scale indicating an amount of distance attenuation.

In various implementations, the audio session parameters further include a reverb value indicative of a reverb characteristic and adjusting the audio data including adjusting the audio to have the reverb characteristic. In various implementations, the reverb characteristic is an amount of reverb (which may be high, low, or none). In various implementations, the reverb characteristic is a reverb accuracy (which may be a full reverb simulation of the physical environment, a reverb amount associated with the physical environment, or none).

While various aspects of implementations within the scope of the appended claims are described above, it should be apparent that the various features of implementations described above may be embodied in a wide variety of forms and that any specific structure and/or function described above is merely illustrative. Based on the present disclosure one skilled in the art should appreciate that an aspect described herein may be implemented independently of any other aspects and that two or more of these aspects may be combined in various ways. For example, an apparatus may be implemented and/or a method may be practiced using any number of the aspects set forth herein. In addition, such an apparatus may be implemented and/or such a method may be practiced using other structure and/or functionality in addition to or other than one or more of the aspects set forth herein.

It will also be understood that, although the terms “first,” “second,” etc. may be used herein to describe various elements, these elements should not be limited by these terms. These terms are only used to distinguish one element from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

What is claimed is:

1. A method comprising:
at a device located in a physical environment, coupled to two or more speakers, and including one or more processors and non-transitory memory:
executing an operating system and an application;
receiving, by the operating system from the application via an application programming interface, audio session parameters including a spatial experience value providing instructions for the spatial playback of audio associated with the application;
receiving, by the operating system from the application, instructions to play audio data;
adjusting, by the operating system, the audio data based on the spatial experience value; and
sending, by the operating system to the two or more speakers, the adjusted audio data.

2. The method of claim 1, wherein the spatial experience value indicates a head-tracked spatial experience and adjusting the audio data includes adjusting the audio data to play from a location in the physical environment.

3. The method of claim 2, wherein the audio session parameters further include an anchoring value indicative of the location in the physical environment.

4. The method of claim 3, wherein the anchoring value indicates a scene having a location in the physical environment.

5. The method of claim 3, wherein the anchoring value indicates a front location in the physical environment.

6. The method of claim 3, wherein the audio session parameters further include a size value indicative of a size of the location in the physical environment and adjusting the audio data includes adjusting the audio data to play from the location in the physical environment having the size.

7. The method of claim 3, wherein the audio session parameters further include an attenuation value indicative of a distance attenuation and adjusting the audio data includes adjusting a volume of the audio data based on a distance between the device and the location in the physical environment.

8. The method of claim 1, wherein the spatial experience value indicates a fixed spatial experience and adjusting the audio data includes adjusting the audio data to play from a location relative to the device.

9. The method of claim 8, wherein the audio session parameters further include an anchoring value indicative of the location relative to the device.

10. The method of claim 9, wherein the audio session parameters further include a size value indicative of a size of the location relative to the device and adjusting the audio data includes adjusting the audio data to play from the location relative to the device having the size.

11. The method of claim 1, wherein the spatial experience value indicates a non-spatial experience and adjusting the audio data includes adjusting the audio data without spatialization.

12. The method of claim 1, further comprising:
receiving, by the operating system, a user input overriding the spatial experience value with a user value; and
adjusting the audio data according to the user value.

13. A device located in a physical environment and coupled to two or more speakers, the device comprising:
a non-transitory memory; and
one or more processors to:
execute an operating system and an application;
receive, by the operating system from the application via an application programming interface, audio session parameters including a spatial experience value providing instructions for the spatial playback of audio associated with the application;
receive, by the operating system from the application, instructions to play audio data;
adjust, by the operating system, the audio data based on spatial experience value; and
send, by the operating system to the two or more speakers, the adjusted audio data.

14. The device of claim 13, wherein the spatial experience value indicates a head-tracked spatial experience and adjusting the audio data includes adjusting the audio data to play from a location in the physical environment.

15. The device of claim 14, wherein the audio session parameters further include an anchoring value indicative of the location in the physical environment.

16. The device of claim 13, wherein the spatial experience value indicates a fixed spatial experience and adjusting the audio data includes adjusting the audio data to play from a location relative to the device.

17. The device of claim 16, wherein the audio session parameters further include an anchoring value indicative of the location relative to the device.

18. The device of claim 13, wherein the spatial experience value indicates a non-spatial experience and adjusting the audio data includes adjusting the audio data without spatialization.

19. The device of claim 13, wherein the one or more processors are further to:
receive, by the operating system, a user input overriding the spatial experience value with a user value; and
adjust the audio data according to the user value.

20. A non-transitory memory storing one or more programs, which, when executed by one or more processors of a device located in a physical environment and coupled to two or more speakers, cause the device to:
execute an operating system and an application;
receive, by the operating system from the application via an application programming interface, audio session parameters including a spatial experience value providing instructions for the spatial playback of audio associated with the application;
receive, by the operating system from the application, instructions to play audio data;
adjust, by the operating system, the audio data based on spatial experience value; and
send, by the operating system to the two or more speakers, the adjusted audio data.
